(19) United States
(12) Patent Application Publication
(10) Pub. No.: US 2012/0053085 A1
(43) Pub. Date: Mar. 1, 2012

(54) Method and Device for Microparticle Assay Fluorescence Intensity Reference Intraplex

(76) Inventor: Brian P. Hanley, Davis, CA (US)

(21) Appl. No.: 13/221,524

(22) Filed: Aug. 30, 2011

Related U.S. Application Data
(60) Provisional application No. 61/378,371, filed on Aug. 30, 2010.
(60) Provisional application No. 61/484,635, filed on May 10, 2011.

(51) Int. Cl. C40B 30/10

(52) U.S. Cl. 506/12

(57) ABSTRACT

A method for making suspended microarray readings from a single sample more reliably accurate. It can be applied to any assay system that uses discrete particles coupled with an assay. Most of these are fluidic systems that read the assay result using flow cytometry. However, other methods such as the distribution of tiny assay devices coupled with miniature transponders, where the sampling is of the environment, can also make use of this method. This invention combines a reference set of signal levels on particles with separately identified assays of one sample. By elimination of outliers, averaging, taking ratios of averages, and then taking ratios of assay signal levels against the reference set this method makes possible highly reliable diagnostics. When used standalone, the method uses different signal intensities to better calibrate an instrument. This method compensates for multiple sources of errors that can occur in this type of assay system.

### RELATED APPLICATION

This application claims priority from the U.S. provisional application with Ser. No. 61/378,371, which was filed on Aug. 30, 2010 and U.S. provisional application with Ser. No. 61/484,635, which was filed on May 10, 2011. The disclosure of ach provisional application is incorporated herein as if set out in full.

### FIELD OF THE INVENTION

The present invention relates to assays, specifically to intraplexing methods for improving the precision of suspended microarray assays. This invention references and is an improvement upon existing patent number 7,501,290, “Intraplexing method for improving precision of suspended microarray assays”, which is incorporated herein as if set out in full.

### GENERAL BACKGROUND AND OBJECTS OF THE INVENTION

A number of patents exist for various forms of suspended microarray assays, including patents for substrate microparticles of various kinds, how their sets are differentiated, processing the array data and what is termed “multiplexing” of assays. A list of these references is submitted in an Information Disclosure Statement accompanying this application. A number of these patents are held by the Luminex® corporation out of Strongsville, Ohio, a company that produces specialized flow cytometers for use with microsphere based suspended microarray assays.

A flow cytometer typically detects signals on one or more channels. Each channel is typically a frequency range produced by fluorescence, and the flow cytometer has bandgap filters corresponding to the peaks of the channels it is configured to detect. In some flow cytometers, up to 12 or more different channels can be differentiated. In the Luminex system, 2 or 3 of these channels are dedicated to differentiating populations of microbeads, nominally in the range of 5 to 15 microns in diameter. A single reporter channel is allocated in the Luminex system for detection of the results of assays. In other flow cytometry systems, a larger number of channels might be dedicated to reporting. This invention relates to use of the reporter channel or channels. It is limited to calibration and reference signals emitted on the same channel or channels that are being used for reporting on a particular instrument.

There are calibration microbead sets used today that exhibit a single fluorescence intensity level. Thus it is necessary to properly differentiate the channel of emission and the intensity of the emission on a channel. The essence of this invention is two-fold, first, that it could be used standalone as an improved replacement for today's single-intensity calibrations on a reporter channel. Second, when combined with assays, such multi-intensity calibration signal emitters may be used as an intra-well reference signal to eliminate variations in signal detection due to the instrument. It is observed also, that one does not find today the use of even a single-intensity reference signal emitter together with assays.

This invention may be used standalone in a flow cytometer as a means of calibration and to diagnose fluctuations in signal detection. There is currently a method for calibration that consists of using a single brightness (signal intensity) standard. The instrument is calibrated based on the assumption that the flow cytometer optical and electronic systems will exhibit an identical response curve as brightness rises or drops from that calibration level. However, response curves to signal can vary between instruments. This invention allows diagnosis of the shape of the response curve as well as its minimum and maximum when it is optimally deployed.

This invention may also be used together with assays which are singular or multiplexed. Of the prior art that covers multiplexing, none discusses how one might make use of a multiplicity of signal intensities to provide a multiplicity of reference signals to suspended microarray assays in order to better determine analyte concentration and to compensate for fluctuations in such variables as (but not limited to) laser fluorescence stimulation intensity, sensitivity of photo-multiplier tube, variations in the minimum or maximum boundaries of the sigmoid curve stimulus-response characteristics of the instrument, or other optical or electronic fluctuations. Nor does any of the prior art discuss how this technique can be combined with single or multiplexed assays to achieve an even higher level of assay precision and repeatability. None of the prior art discusses how such a multiplicity of suspended microarray reference signals can be used to eliminate instrumentation variances, diagnose irremediable differences and make accurate estimates of true concentration of analytes.

This invention provides a method and device for providing a high precision reference calibration for each assay conducted in a flow cytometry system by establishing one or more calibration fluorophore levels in the reference set. This allows compensation for relative brightness and responsiveness of fluorescence electronics while conducting each assay and for fluctuations in same. This invention is useful in multiplexed and single assays and is a type of intraplex when it is used together with a single assay or multiple assays.

To define intraplexing clearly, special terminology has been created because without it, experts became confused as to what exactly was being referred to. For this reason, a single particle (which is, for Luminex®, a microsphere) is called an SMP (suspended microarray particle.) A set of microspheres that are all labeled with the same classifier is called an SMPCS (suspended microarray particle category set). (Hence, SMPCSs is the plural form of SMPCS.) These two differentiations are all that is necessary for understanding suspended microarray systems. An SMPCS corresponds to what Luminex® commonly calls “a microbead region”, a “microbead set” or more colloquially, “a microbead” and is usually interchangeable with “bead number”, since Luminex® classifies their microsphere sets to users by numbers from 001 to 100 in their two dimensional multiplex systems, and their FlexMAP 3D™ can differentiate up to 500 different microsphere classifiers. From here on, all discussion of bead numbers will be in the context of the 2 dimensional system, but it will be implied that a similar system will work for the three dimensional system.

Reference set intraplexing also introduces a new set, which is the “suspended microarray particle reference set” or SMPRS. (Likewise SMPRSs is the plural form.) An SMPRS has a single fluorescence intensity level that is designed not to change when inserted into a sample, and for any single SMPRS, the fluorescence signal intensity may vary between a reference minimum and a reference maximum. A set of SMPRSs may be designed such that there may be more than one bead set bearing the same intensity of reference fluorophore. This is called an SMPRS Identical Group, or SMPRS-IDG (also SMPRS-IDGs is the plural form).

Bearing this introduction in mind, these terms are discussed in more detail below.

A suspended microarray system uses a population of suspended microarray particles (SMPs), all of which have one assay on their surface. These SMPs are run through a flow cytometer after running an assay protocol. The flow cytometer has a flow cell which differentiates individual SMP events as they go by. Thus, the result is a statistical sampling of the population of the SMPCS made up of individual readings of the SMP events. These individual event readings are not identical, but are usually distributed in an approximate normal curve. Conventionally, most of these SMP-based assays use fluorescent reporter molecules to provide a signal, but there are other methods. If multiple SMPCSs are present in a well, then more than one analyte can be assayed simultaneously in the same assay plate well. This is termed multiplexing of assays, and it is a primary selling point for current suspended microarray systems.

A multiplexed assay comprises different suspended SMPCSs—where each SMPCS has an assay for a different analyte, and the SMPCSs are mixed together in one test tube or assay plate well. Conventional assay plates currently contain up to 96 wells in one plate, wherein each well contains fluid to be assayed, as shown in prior art FIG. 4. In use, each of the 96 wells in the plate is loaded with some analyte in a fluid medium. Into each well are injected suspended microarray particles with assays on them, and then an assay protocol is performed. Finally, the 96 well plate is inserted into a robotic sampler that feeds a reading instrument. Typically, the reader is a flow cytometer. The robotic sampler inserts a hollow probe, usually column by row, one well at a time, sucking up a sample of fluid mixed with SMP's, moving the sample acquisition probe from one well to the next.

Another assay method is an environmental assay method sometimes known as “smart dust” which consists of a tiny electronic chip, (that can be microscopic) and that has an assay built into it, generally on its surface. This assay device usually receives energy from the environment in the form of sunlight, or from a reader device in the form of microwaves. The device acts as a transponder, sending the result of the assay to the reader device. Some of these devices work in fluid, while others broadcast the particles (“smart dust”) over a region which may be outdoors. These broadcast assays indicate to the reader what is present in the environment. There are many identical copies of each assay particle in a broadcast system, and the signals returned can be analogous to signals returned by microspheres in a flow cytometry system, having many separate readings for the analyte that are combined to produce one value. In an environmentally broadcast assay system of this kind the equivalent of the test tube or well in a plate is the responding region containing particles that fall within an area the reader can detect. As the reader is moved, this area changes as particles are added on the leading edge of movement, and lost on the trailing edge. Totalizing of readings for a region can occur by making arbitrary distinctions between one such region and the next. In this type of system, as with fluid suspensions, a set of SMPCS assays could be created where each assay reacted to the same analyte. The results could be collated and processed in an analogous manner to that of intraplex assays taking place within a fluid medium. Likewise, a set of SMPRSs could be created for use in providing normalizing ratios.

The standard method for flow cytometry to determine concentration of an analyte uses a set of reference samples to produce what is known as a “standard curve”. By comparing the results from defined concentrations of the analyte put into the standards at differing concentrations, the concentration in a sample is interpolated.

As mentioned above, a problem with multiplexed assays of this type is that there can be fluctuations in the laser, photomultiplier tube, or other parts of the optical or electronic system. This can create intra-plate variances that can be significant between the results as determined by the standard curve and the true concentration. Additionally, the precise characteristics of laser illumination, photomultiplier tubes and other parts of the optical or electronic system can vary between instruments. This can include higher levels of background signal that determine the minimum and lower levels of maximum signal. The rate at which signal detection drops off with signal emission level can vary between instruments. This and other differences can create distortions of the optimal sigmoid curve of stimulus-response that is detected.

Thus, there is a need to improve the reliability of such assays and to compensate for multiple potential sources of error that are, at present, hidden to the user of the instrument.

In addition, it is desirable to be able to do away with the standard curve for determination of concentration in order to increase the number of samples that can be run for each instrument, or to have a second method that validates that the standard curve results are correct.

It is therefore a primary object of the invention to improve the precision with which each analyte can be read in any type of suspended array assay system by using a plurality of SMPRS readings as a reference standard for each SMPCS.

It is a further object of the invention to make possible processed readings that have high correlation between instruments, even if the instruments have significantly varying responses to identical stimulus, and different slopes or curves of response to signal. Experiments have shown that instruments can vary significantly when reading exactly the same SMPCSs.

Other objects and advantages of the present invention will become obvious to the reader and it is intended that these objects and advantages are within the scope of the present invention.

### SUMMARY OF THE INVENTION

This present invention provides a method for making readings from suspended array assays more reliable. The method may be applied to any type of suspended array assay systems that use a plurality of individual readings from small (generally microscopic) particles coupled to an assay. This invention combines the readings from one or more SMPRSs with readings from SMPCS assays obtained from a sample, wherein the one or more SMPCS assays are for any or all analytes in the sample. By elimination of most instrument-based fluctuations between samples, this method makes highly repeatable and hence reliable diagnostics possible. This method compensates for multiple sources of errors that can occur in this type of assay system.

The Applicant's method provides more reliable readings and diagnoses various errors in these types of assays. Potential sources of variance that can be compensated for include: intra-instrument fluctuations that occur during operation, inter-instrument differences in sensitivity and inter-instrument calibration differences (including response curve for varying concentrations of analyte by the complete opto-electronic system.)

The advantages of the Applicant's system are that the system (1) makes possible compensation for multiple sources of error, (2) makes possible increased precision for each analyte, and (3) makes possible processed readings that have high correlation between instruments, even if the instruments have significantly varying responses to an identical stimulus, (4) provide a basis for estimating margin of error in concentration where large calibration sets are recorded by manufacturers of assays to establish estimates of standard deviation.

A first and preferred embodiment of the Applicant's method is what is known as a first-order reference intraplex assay, in which there is a set of m SMPRSs bearing different reference fluorophore signal levels which are used as a reference against signals from suspended microarray assays in the sample. A second-order reference intraplex is also detailed. This is an m×n matrix of m SMPRSs bearing different reference fluorophore signal levels that have n duplicated SMPRSs that should give the same signal level. In this, both m and n are numbers greater than or equal to one and n can be unique or identical for each of the m SMPRS reference signal levels. These are combined so that readings from multiple different analytes can be normalized to the SMPRS reference fluorophore standards following the Applicant's novel method.

This invention provides, for the first time, reference fluorophore standards through the range or a subset of the range of detection capability for instruments when used standalone for calibration or as a diagnostic. This is opposed to conventional systems which may run a reference calibration on the instrument separate at a single signal level.

This invention provides, for the first time, reference fluorophore standards through the range or a subset of the range of detection capability for instruments when used at the same time as each assay is being conducted. This is opposed to conventional systems which may run a reference calibration on the instrument separate from the assay procedure, and may have positive or negative control assays in a multiplex.

The present invention allows for the specific determination of:
a. the degree of resolution of fluorescence;
b. the range of or a subset of the range of fluorescence detection; and
c. the degree of accuracy of the reference fluorophore set(s)
   at the same time as each assay is being conducted. This can compensate for fluctuations and differences in sensitivity and illumination source brightness. This can also provide more information as to the accuracy of the assay(s) being conducted.

Each assay may be measured against the level(s) of the reference fluorophore(s) sets in the multiplex, and by interpolation by some method to determine brightness against the calibration sets. In this way the reference fluorophore sets become an invariant standard between assays conducted on different instruments or at different times on the same instrument.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1A depicts a first-order reference intraplex concept diagram showing idealized characteristics where m=5 different microsphere sets (i.e. 5 SMPRSs) labeled 001 to 005. Symbolic rays are shown emanating from each microsphere intended to indicate different degrees of fluorescence for each set. Different densities of fluorophore are coated on or embedded in the surface of the microspheres.

FIG. 1B shows simulated reference fluorescence readings, as processed by the instrument, for an assay that reflects 2× series dilutions of fluorophore coated on or embedded in microspheres. This graph shows how each SMPRS provides a different fluorescence signal level. In this diagram, 001R corresponds to the instrument reading for SMPRS 001 of FIG. 1A, 002R corresponds to the instrument reading for SMPRS 002, and so on. Mean of the set of m SMPRS-IDGs=6200 is denoted by horizontal line. This mean is the internal self mean of the m fluorescence readings.

FIG. 1C shows internal self mean ratios for each of the 5 SMPRS instrument readings of FIG. 1B. An example calculation is shown for SMPRS 001. In this diagram, 001A corresponds to the ratio of 001R to the internal self mean of the m instrument readings, 002A corresponds to the ratio of 002R, and so on. The mean of the set of m SMPRS-IDGs is used as the denominator for each of the m fluorescence readings obtained by an instrument.

FIG. 2 is a diagram conceptualizing a second-order intraplex, an m×n SMPRS based assay, where the SMPRSs are microspheres. Each circle in this diagram represents an SMPRS. The set of m is a composed of 4 SMPRS-IDGs labeled across the top, IDG1-IDG5 with each member of the set outlined with dotted lines. Each SMPRS classifier's label is within each circle. Each of n (001 to 005 for SMPRS-IDG 1, 006 to 010 for SMPRS-IDG 2, etcetera.) SMPRSs that make up the SMPRS-IDG for each of m sets is designed to show substantially identical fluorescence. (However, in practice, there is always some variation in fluorescence.) Down the left side of the diagram are shown the indices of n, as n1-n5 for reference. Like FIG. 1A, the m SMPRS-IDGs would be manufactured using serial dilutions (or some other useful difference in sensitivity method).

FIG. 3A-3C shows the processing of the reference intraplex from FIG. 2 using a simulated example.

FIG. 3A (Step 1) shows the m=4×n=5 SMPRS reading dataset graph for all SMPRSs, 001-020. In this diagram, the n axis is labeled S1-S5 to denote the indices of n for all the members of the SMPRS-IDG dataset. The m axis is labeled IDG1-R to IDG4-R to indicate the readings for the SMPRS-IDGs in the dataset. The outlier at IDG1-R, S5 is removed from the set of n of SMPRS-IDG 1. This changes the result when the mean of the set of n SMPRSs is calculated in Step 2 below. Completion of Step 1 is removal of outliers that are identified.

FIG. 3B (Step 2) shows the result of this step is m averages, (means of the sets of n SMPRSs) using as input the n microsphere set fluorescence readings for each SMPRS-IDG. The resulting mean of the set of n SMPRSs data is shown in the table. Each of these 5 means of the sets of n SMPRSs are then averaged together to give a single mean of the set of m SMPRS-IDGs.

FIG. 3C (Step 3) shows the internal self mean ratios calculated using the mean of the set of m SMPRS-IDGs as denominator for each of the means of the sets of n SMPRSs, from the calculations of step 2. This is done in the same way as for the first-order intraplex of FIG. 1.

FIG. 4 is a diagram of a typical 96 well assay plate, having rows A-H and columns 1-12. This is supplied for illustration purposes to help visualize the current art. The section in the upper left with a line drawn around 5 pairs of wells D is an example of an area of a multi-well plate that would be used for inserting standards for generating a standard curve for the plate. While wells, D, is shown by way of example, the number of standards wells used in practice varies depending on how detailed the standard curve is desired to be.

FIG. 5 is a concept diagram showing the Verhulst curve (i.e. sigmoid curve) typical of a signal detection apparatus. In this diagram, the x-axis increases from left to right signifying increase in signal intensity. The y-axis increases from bottom to top signifying the level of detection of the signal where 100% indicates the end of the intended design range for the detector, and 0 represents no detected signal in a perfect detector without noise. Such a detector cannot be built, but can only be approached, typically by methods such as chilling the detector to extremely low temperatures. At the bottom of the diagram is a horizontal dashed line which signifies normal level of noise in the detector. Below this threshold no signal can be differentiated. Near this lower threshold of signal detection the relative differences between detected signals do not vary greatly. Something similar occurs as the detector reaches the point at which no more signal makes any difference. In a real world example of a camera, as illumination becomes brighter and brighter, this maximum detection level might be called over-exposed until there is nothing but white light in a photo.

### DETAILED DESCRIPTION OF THE INVENTION

The Applicant discloses several reference intraplex embodiments and provides guidance for the method to be applied to other situations. Although it will be described in relation to suspended microarray assays using a typical 96 well assay plate which typically suspend particles in fluid before reading the result via flow cytometry, the method may be applied to a variety of different types of particulate based microarray assays using various numbers of samples. In such assays, an assay is bound to the particle surface, and a protocol is run that results in a signaling event such as fluorescence indicating presence of analyte. Such assays include microspheres, microbeads, magnetic microbeads, bar-coded microrods, and microtransponders. (“Smart dust” is the distribution of tiny assay devices coupled with miniature transponders, where the sampling is of the environment, and it can also make use of the reference intraplexing method.) It is not necessary that the physical or chemical method of generating a fluorescent reference signal be identical for each of the suspended microarray reference intraplex SMPRS's. It is only necessary that the end result be a predictable difference in reference signal level that can be reliably read for a given SMPRS for each of the m SMPRSs.

For purposes of the patent application, the term “reference intraplexing” and “reference intraplex” shall refer to the execution of the applicant's method. A “reference intraplexed assay” is one in which the reference intraplexing steps as defined have been performed.

An SMP is a suspended microarray particle. This is one particle, such as a microsphere, microbead, a microrod or some other microscopic particle assay device that can be suspended in a liquid medium, or broadcast over some area. It may have attached to or embedded in its surface an assay or a means of providing a reliable reference signal.

An SMPCS is a suspended microarray particle category set. This is a population of a multiplicity of microscopic particles such as microspheres, microrods or some other microscopic assay device, (see SMP) which has a marker system to allow categorization of a set by a reader instrument. In the Luminex® system, this is done by using two different long wavelength fluorophores that are varied as to proportion so that the set of particles can be categorized. The resulting two-dimensional matrix has regions to which numbers are assigned and can differentiate up to 100 different categories. As stated above, the Applicant's methods apply to a variety of situations, such as that involving a new instrument able to differentiate up to 500 different categories.

An SMPRS is a suspended microarray particle reference set that has a single fluorescence intensity level, and for any single SMPRS, the fluorescence signal intensity may vary between a reference minimum and a reference maximum.

A superset of SMPRSs is introduced, which is the “suspended microarray particle reference set identical group” or SMPRS-IDG.

The “mean of the set of n SMPRSs” shall refer to the average of all the SMP reference sets (SMPRSs) in a reference intraplex that comprise an SMPRS-IDG. By extension, “means of the sets of n SMPRSs” shall be the plural form.

The “mean of the set of m SMPRS-IDGs” shall refer to the average of all the SMPRS-IDGs in an intraplex that have different level of calibrated signal. A “mean of the set of m SMPRS-IDGs” may use a set of one or more “mean of the set of n SMPRSs” as its input, where each “mean of the set of n SMPRSs” defines one of the m values used to calculate the mean of the set of m SMPRS-IDGs.

The “SMPRS internal self-mean ratios” shall refer to the ratio of the means of the set of m SMPRSs to the average of the means of the set of m SMPRSs as denominator, which are m in count, where m is greater than or equal to 1. Additionally, “SMPRS internal self-mean ratio” may also be used to refer to the reciprocal of the preceding definition.

“q ratios” shall refer to the set of ratios of the means of the set of m SMPRSs as numerators, over the means of the set of m SMPCS-IDGs as denominators, which are m in count, where m is greater than or equal to 1. Additionally, “q ratios” may also be used to refer to the reciprocal of the preceding definition.

“p ratios” shall refer to the set of ratios of the SMPRS internal self-mean ratios as numerators over the means of any or all of the set of m SMPCS-IDGs for assays taken from the sample well as denominators, which are m in count, where m is greater than or equal to 1 and where m may be different for the SMPRS and for the SMPCS-IDGs. Additionally, “p ratios” may also be used to refer to the reciprocal of the preceding definition.

The “range of p or q ratios” shall be defined as the absolute values of each of either p or q ratios to each of the other ratios in the set of p or q ratios or to the absolute value of the difference between the minimum and the maximum values of any set of p or q ratios. The range of p or q ratios would normally be used in a large calibration reference dataset for an assay to an analyte to determine probable concentration of an analyte without reference to a standard curve.

“SMP event readings” shall refer to the set of individual events detected by an instrument used to detect the signal(s) from a set of microparticles on which an assay has been attached or a reference signal generating material has been provided.

“SMPRS readings” shall refer to the processed results of the reference intraplex sets presented by an instrument system that is used to evaluate some reference standard signal (which could be some radio frequency, fluorescence or some other detectable physics) from a set of SMP events. Typically, this would be presented as an arithmetic mean, a median, a peak (which is analogous to mode) or something similar. A user may have a choice of which of the values presented by the instrument system they will choose to use. When user choice is allowed, all of the choices available are considered “SMPRS readings” if they are used. A user might wish to further process the set of available SMPRS readings into a single numeric value by some arbitrary method, and if this was done, that value would also be considered an “SMPRS reading”.

“SMPRS value” is an alternative way to refer to a number representing the result of reference intraplex sets for a sample of a population of reference intraplex microparticles, as detected by an instrument system.

The term “classifier” shall refer to the code that is used to identify all of the SMPs within one SMPRS or SMPCS. By extension, the term “classifiers” shall be the plural for a multiplicity of SMPRSs or SMPCSs. (I.e. in the Luminex system, these are numeric values from 001 to 100 that are based on the technology of varying intensity of two fluorophores by log base 2 in 10 steps yielding a 10×10 set of differentiable particle sets.)

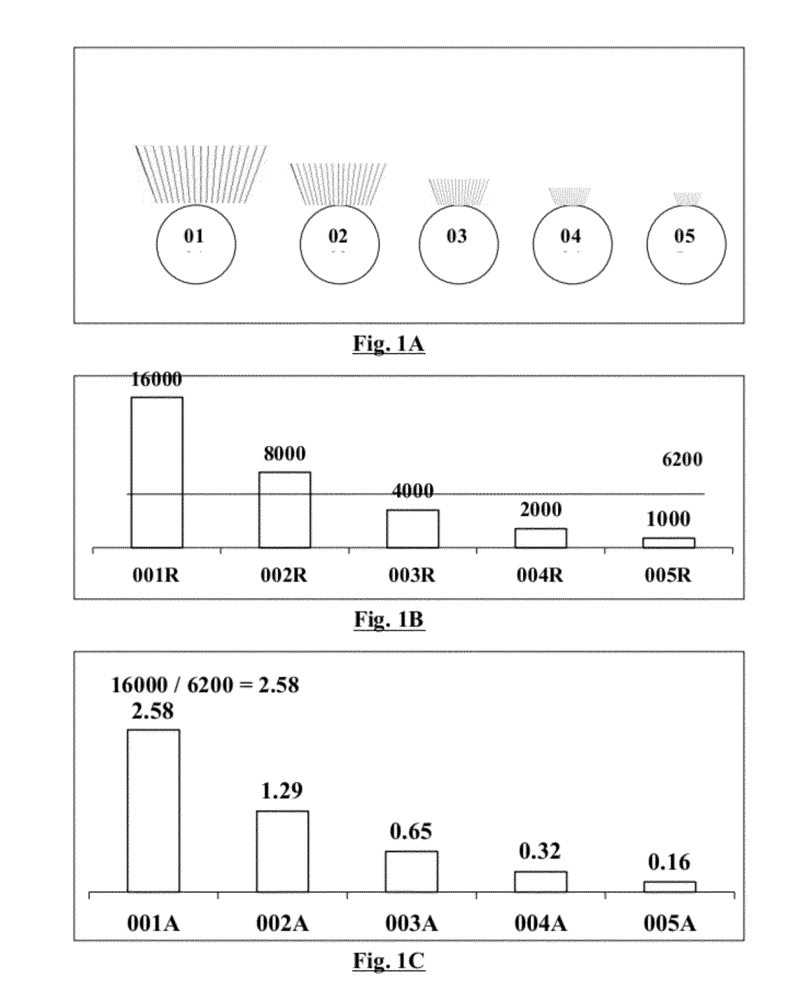

A first and preferred embodiment of the Applicant's system shall be referred to as a first-order reference intraplex, in which there is a set of m SMPRSs wherein each of the m SMPRSs has a different signal level. In this case a single copy of each reference signal level is used (i.e. n=1). As shown in FIG. 1A-1C, said first-order reference intraplex is fluorescence on microsphere type particle set. This is one type of signal used and is presented here as an example only. When illuminated with laser of the right frequency, the reference fluorophore fluoresces, which the flow cytometer reads as an intensity level. Here, each SMPRS is titrated during the manufacturing process to give a different response to the illumination by the laser. The readings comprising multiplicities of SMP event fluorescent intensities are shown as a chart in FIG. 1B. This will typically be performed by coating them in differing concentrations of whatever fluorescence material is needed in order to provide an appropriate level of signal. Ratios of p and/or q are taken and further additional ratios and relationships may be creatively defined.

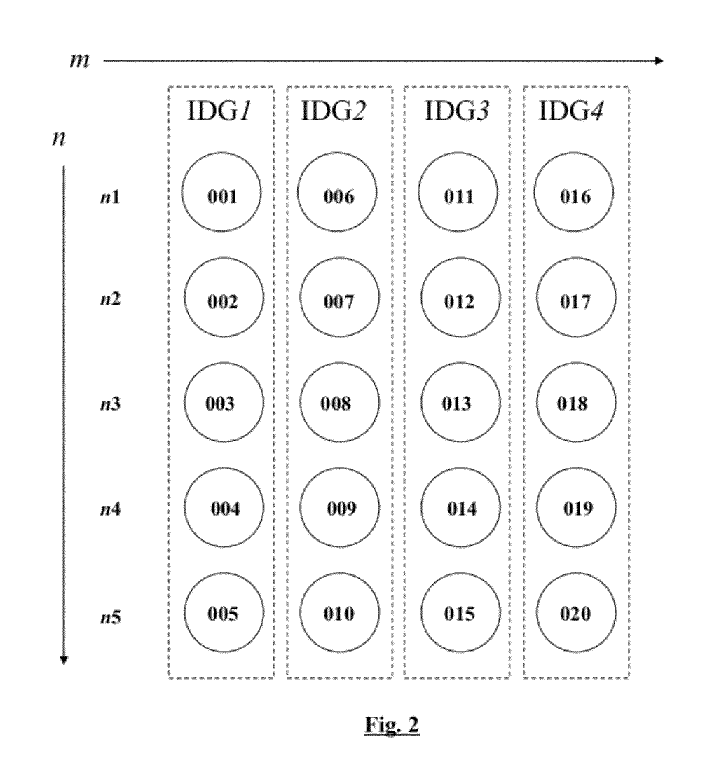

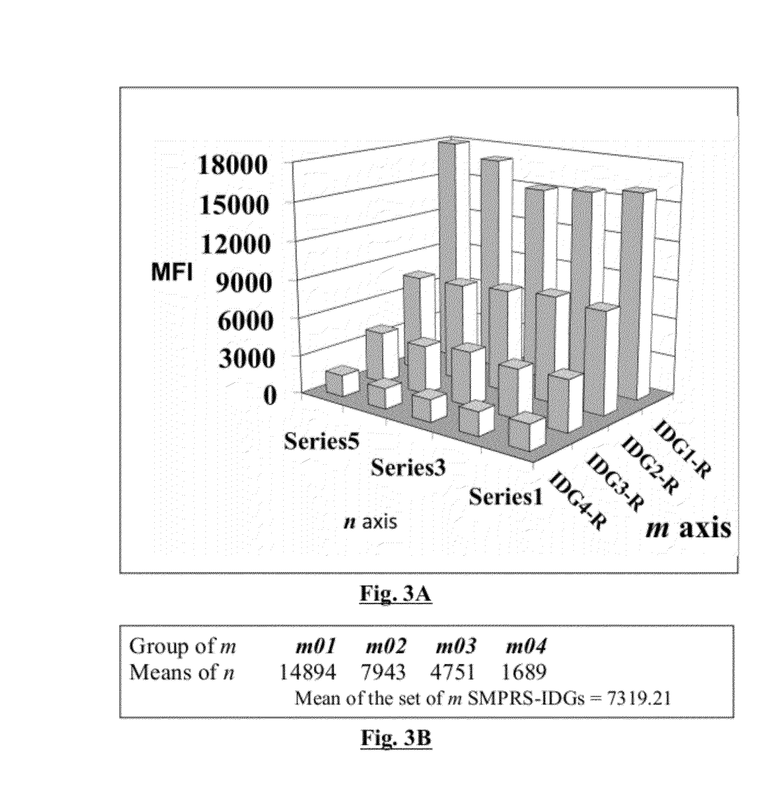

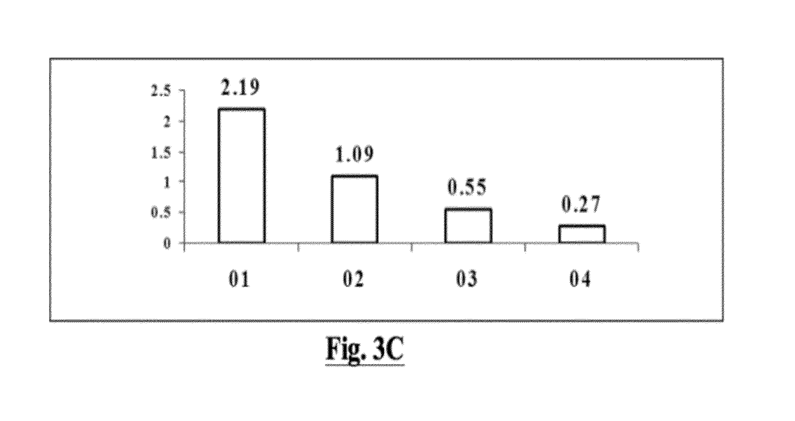

A second embodiment, a second-order reference intraplex is an m×n matrix in which m different SMPRS-IDG signal levels have n identical SMPRS signals, as shown in FIG. 2. In FIG. 2, each circle in the diagram represents a set of reference intraplex microspheres (i.e. an SMPRS). Each of the superset identical groups (i.e. SMPRS-IDGs)(m=4) is manufactured so as to present different reference signal levels. The SMPRS-IDGs of m are across the top, labeled IDG1, IDG2, IDG3, and IDG4. Note that now each m is a superset comprising 5 microsphere set classifiers (i.e. an SMPRS-IDG). Each of n (01 to 05 for SMPRS-IDG 01, 06 to 10 for SMPRS-IDG 02, and so on) microspheres that make up the superset SMPRS-IDG for m is typically manufactured in the same batch for identical reference signal. Like FIG. 1A, the m SMPRS-IDGs have serial dilutions (or some other useful method for creating different levels of fluorescent signal) in their manufacture. FIG. 3A-3C shows processing of the intraplex using a simulated example. 3A-Step 1: An m=4×n=5 fluorescent reference reading dataset graph for all SMPRSs, 01-20. The readings for the set of m are denoted by IDG1-R, IDG2-R, IDG3-R, IDG4-R. (Note the outlier at {IDG1-R, S5} that was removed for the set of n for the m IDG1-R for the next calculation step.) Completion of step 1 is removal of outliers should they be present. 3B-Step 2: The result of step 2 is m averages, (means of the sets of n SMPRSs) using as input the n microsphere set readings for each SMPRS-IDG. This is shown in the table. Each of these 4 means of the sets of n SMPRSs is averaged together to give a single mean of the set of m SMPRS-IDGs. In this table, m01 corresponds to mean of IDG1-R, m02 corresponds to mean of IDG2-R and so on. 3C-Step 3: Internal self mean ratios are taken using the mean of the set of m SMPRS-IDGs as denominator for each of the means of the sets of n SMPRSs from step 2. In this diagram, 01 corresponds to a ratio made with m01 as numerator, 02 corresponds to a ratio with m02 as numerator, and so on. This is done in a similar way as for the first-order reference intraplex of FIG. 1. Step 4 (not shown): Ratios of p and q may be then taken to any or all SMPCSs and/or SMPCS-IDGs bearing assays on their surface.

Note that it is not required that the number, n, of identical reference intraplex SMPRSs be the same for each of the m different reference signal levels.

In summary, the reference intraplex method diagrammed in FIG. 3A-3C includes mathematical and statistical processing steps including (3B) to remove outliers from n values if they are present. (3C) averaging of remaining values from the n set to produce m means of the sets of n SMPRSs and further averaging the m means of the sets of n SMPRSs to produce a mean of the set of m SMPRS-IDGs. (3D) taking of ratios between the each of the m means of the sets of n SMPRSs, and the mean of the sets of m SMPRS-IDGs and using them to obtain p and q ratios.

A third embodiment, a degenerate second-order intraplex where m=1 containing only one set of n≧1 (usually n will be >2 but it is not required) identical reference intraplex sets, will be still more reliable when p and/or q ratios are taken than without it. In this case, a simple three-step process will be used including (1) removing of outliers from the n values should n be greater than 2, (2) averaging of the remaining values from the n set to produce a useful reference, (3) taking of q ratios to normalize the readings obtained from assays. In this case p ratios are not meaningful.

In typical operation, any SMPCS assays are added into a standard well in an assay plate, or to another test-tube analogue. The assays are read by an appropriate instrument for the microparticle system this assay method is applied to. For some SMPCS assays this could be any flow cytometer, for others it may be best achieved by using a specialized flow cytometer optimized for a particular set of identification markers or by an RF detector. These readings are interpreted by software that is informed of how reading sets should be grouped for each intraplex assay. The software may have pre-set calibration response curves and margins of error for each intraplex assay as defined by the manufacturer as these could be pre-determined using this reference intraplex method. The software performs appropriate statistical processing on the set of intraplex readings, and returns a set of values to the user of the software, which represents the intraplex assay results. These results may be correlated by the software with a range of concentrations for the analyte in question. Software is not strictly necessary, it is a convenience. Analysis may be done by hand, by spreadsheet, statistics software or some special-purpose software. The analysis results in either a reading showing a signal level, which is compared to some standard value range, or a concentration, such as picograms per milliliter interpolated from a standard curve.

In an alternative embodiment of the invention, there is some flexibility in the three algorithmic processing steps. In step one, the algorithm for determining whether an individual reading of a set is an outlier can vary. In step two, the averaging method used may not be a simple arithmetic mean, but instead one of a variety of other methods for determining an average, such as arithmetic mean, geometric mean, harmonic mean, or quadratic mean. All of them can be used to produce different numerical results that can then be used, as long as they are used with appropriate consistency. In step three, ratios may be taken between the available averages. What is important is that the basic concepts are applied. A software developer may choose any variants they find useful, including elimination of a step.

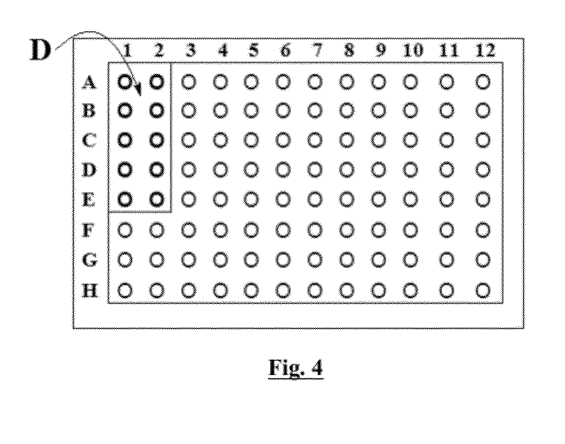

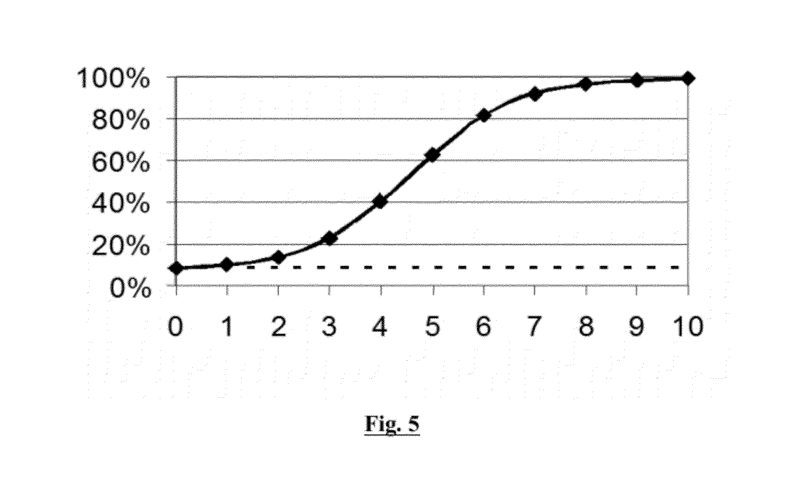

A fourth step may be performed that provides a concentration estimate for reference intraplex assays. Typically, a standard curve is made for each assay plate. As shown in FIG. 4, a typical 96 well assay plate having rows A-H and columns 1-12 may be used. Fluid samples are placed in each of the 96 wells. Col. 1-2 Rows A-E, highlighted in bold in FIG. 4, are standards wells. A typical set of standards for a plate such as that shown in FIG. 4 would be 6 pairs of wells, where each pair of wells contain identical concentrations of the calibration standard fluid, and successive pairs are sequential dilutions. The standard fluid contains known quantities of analytes. Typically, the first pair of wells contains a full strength standard fluid, the second pair is diluted 1:2, the third pair is diluted 1:4, fourth pair is diluted 1:8, and fifth pair 1:16. SMPCSs and SMPRSs for the desired analytes are injected into all wells, both standard containing wells and sample containing wells. The pair of processed readings (e.g. p and/or q ratios) for each titration of the standard wells is averaged and the 6 averages used to generate a “standard curve.” Using the standard curve, processed readings from other wells in the plate can be interpolated as to their concentration.

For reference intraplex concentration estimate, an assay developer can create a standard curve for the assay using one or more plates, each of which contains as many wells as desired for the standard curve. For example, instead of 6 or so titrations for which interpolation is done, a large number of titrations, perhaps across multiple plates could be made. The total number of titrations could be arbitrarily high, for instance 180 or more. These titrations can be closer together and extend well into the non-linear region of the sigmoid standard curve to better characterize it. These standard curve plates can be repeated as many times as the assay manufacturer deems useful to ensure reliable results, and the manufacturer can run the plates on multiple instruments to compare results. Such a standard curve plate or plates can be run for each batch lot of reference intraplexed assays, and generally this would be done as a quality control method. Note that in this way it is not strictly necessary that a manufacturer replicate each of m reference intraplex signal levels precisely, since they could recalibrate their assays for each batch lot set together. The developer can then define estimated concentration of analyte and margin of error by correlating known concentration with such features as the range of m ratios, fitting curves to the ratios by numerical methods or derivatives of the curves fitted, when ratios are graphed as points where, for instance, the y coordinate is the ratio and the x coordinate is a useful value selected by the developer for each of the m ratios. For instance, given a set of m ratios as shown in FIG. 3C, of {2.19, 1.09, 0.55, 0.27} as y coordinates, a developer might choose {1, 2, 3, 4} as the respective x coordinates. In such ways, a developer would produce a “predetermined calibration dataset”. Within this dataset could be ratio ranges, fitted curves, derivatives of fitted curves for use in evaluating estimates of concentration of analyte for intraplex assays.

An additional method that could be used for estimation of concentration of analyte is clustering of ratios using a K nearest neighbor (Knn) algorithm or a neural net system. In K nearest neighbor, the ratios are used as N dimensional vector sets. This transformation into an N dimensional vector set can be done in a variety of ways which would be up to the software developer. Each vector set defines a point in N dimensions, and is then assigned a meaning value. The meaning response value would be a concentration. When a new vector set is supplied to the system, it also defines a point in the N dimensional space. The algorithm then returns the nearest neighbors as limited by a value, d, which is a maximum distance in the N dimensional space for any responders. The response is composed of a set of meaning values, each paired with vector distance from the new value. This allows an interpolation to be performed using the meaning values.

Example of a K nearest neighbor system (Knns) in use. For this example we will use a simple 2 dimensional plane with x and y coordinate axes. The Knns is “trained” by supplying it a series of 4 vector pairs. These are: |{1,0}, {2,1}, {3,1}, {4,2}|. These four pairs are assigned meaning values of: {0, 5, 7, 10} respectively. To use the Knns a pair of numbers is supplied, {3, 2} using a distance, d, of 2. The system would then find the points within a circle of radius 2 from {3,2} and return three value pairs consisting of: {meaning value, distance} |{5, 1.4} {7,1} {10,1}|. This is because the point {3,2} is a distance of 1.4 from {2,1}, and a distance of 1 from both {3,1} and {4,2}. Note that for m reference intraplex response levels, there would generally be m or more dimensions to the vectors, so this example is highly simplified.

This calibration dataset from the developer can be supplied with an assay kit so that estimation of concentration from intraplex results can be performed either manually by the user, or by software. It might be desirable for an assay manufacturer to automatically download calibration datasets into intraplex interpretation software retrievable by assay lot identifier.

Using predetermined calibration datasets reference intraplex assays do not necessarily require the use of standard fluids and standard curves on every plate to determine concentration of analytes. This provides opportunities for logistical improvement in certain diagnostic tests. Where standard curve methods are used for every plate of samples, intraplex derived concentration estimates can provide a crosscheck on the usual standard curve system to improve their reliability as diagnostics.

The intraplex invention has wide application for providing high precision assays that are typically read by flow cytometry. This type of assay is applicable also to assays such as “smart dust” and others that may not be suspended, but are instead distributed over some region to assay for analytes. The limit of the type of assay that this is applicable to is assays wherein the reading is made up of a collated set of readings from small particles. Those small particles may be of variable shape, and the particles have a means for providing a signal indicating the level of analyte detected.

A fourth embodiment of the invention is the preferred form for a standalone reference intraplex used for calibration of an instrument. This embodiment corresponds to the first-order reference intraplex with the difference that there are no assays used with it and there are, therefore, no q or p ratios that apply. In this embodiment there is a set of m SMPRSs wherein each of the m SMPRSs has a different signal level. The signals would be mapped onto the relative response each SMPRS achieves. As seen in FIG. 5, this allows signal detection to be determined in relationship to manufacturer's signal intensity. In current assays assumptions are made about the shape of the standard curve which are not necessarily valid. By running one or more complete or partial plates containing the reference intraplex it will be possible to diagnose fluctuations in signal detection for the instrument.

Alternatively, the fourth embodiment may comprise an m×n matrix in which m different SMPRS-IDG signal levels have n identical SMPRS signals, as shown in FIG. 2. This embodiment corresponds to a second-order reference intraplex with the difference that no assays are used in conjunction with it.

A fifth embodiment is an alternative for use as a standalone reference intraplex. In this embodiment, the fluorophores could present within a single SMPRS. In this embodiment of the invention, there would be m peaks in the event histogram for one SMPRS, where m signifies the number of different signal levels in the reference intraplex. By observing the peaks present at different intensity levels, and assuming that count events within some positive and negative deviation from each of the m peaks represented different reference signal intensity regions, each the various calibration levels could be differentiated. Since it would be known a-priori that each level of fluorescent intensity should be present, the levels could be inferred both by relative intensity step and by relative spacing between the steps.

Now that the steps involved in the applicant's method have been adequately detailed, several example implementations of the steps will be described. For each of these examples, it is assumed that there is no significance to the SMPRS classifiers selected being consecutive, only that they are different from each other. The examples below are not necessarily described in order of preference, but are instead organized for ease of understanding.

Example 1—A simple first-order intraplex. In this example, m=6, meaning 6 different SMPRSs are used. In the Luminex® system, microspheres are used for the SMPs, and one could select SMPRS 001, 002, 003, 004, 005 and 006. Some fluorophore is attached to or embedded in the surface of the SMPRSs. For SMPRS 001, a fluorophore concentration is applied in the reaction vessel that will provide the maximum signal from the SMPRS. For the second SMPRS, the concentration of the fluorophore is diluted so as to result in a lower signal from the SMPRS. A typical dilution factor might be 2, 3, 10 or whatever is determined to work appropriately. Each SMPRS in turn is manufactured with a serial dilution such that the end result will be 6 SMPRSs, wherein each of the 6 SMPRSs gives a different signal level when stimulated. After the manufacturing steps are complete, the SMPRSs are combined together and injected into the assay plate well so as to provide approximately the same number of SMP's for each SMPRS (for instance, if there are approximately 2000 of SMPRS identifier 001, then there are approximately 2000 of SMPRS identifier 002, etc.)

Each SMPRS will present a distribution of readings. In the Luminex® system, a variety of information is presented to the user, including mean and trimmed mean, peak and trimmed peak, (which are similar to mode) and median and trimmed median. It is often recommended to use median. In practice, it makes little difference which is used as long as the choice is consistent. Whichever value is chosen for use, that value becomes the reading from the instrument for the SMPRS s. For example, a first order reference intraplex presents 6 SMPRS values. After this, 6 ratios are then taken against the mean of all 6 SMPRSs with the SMPRS reading as the numerator and the master average (mean of the set of m SMPRS-IDGs) as the denominator. Following this, p and q ratios can be taken as desired against the SMPCS assays.

Example 2—A second order intraplex. In this embodiment and example, m=4 and n=5, meaning 20 SMPRSs are selected. In the Luminex® system, microspheres are used for the SMPs, and for purposes of this example one could select SMPRS 001 to 020. The SMPRSs are then divided into 4 subsets of 5 SMPRSs each. (Each set of 5 will be an SMPRS-IDG.) For each of the 4 subsets of 5 microspheres, all 5 microsphere sets are combined in a reaction vessel. Some fluorophore is attached to or embedded in the surface of the 5 SMPRSs. For the first identical group subset of 5 SMPRSs, (first SMPRS-IDG) a fluorophore concentration is provided in the reaction vessel that will provide the maximum fluorescence reading wanted. For the second subset of 5 SMPRSs, the concentration of the fluorophore is diluted so as to provide less fluorescence on stimulation. A typical dilution factor might be 2, 3, 10 or whatever is determined to work appropriately. The end result of this will be 4 subsets of 5 SMPRSs, (or 4 SMPRS-IDGs) wherein each of the 5 SMPRSs in a subset are coated the same, but there are 4 different subsets that should give different fluorescence signal level on stimulation. After the manufacturing steps are complete, the 4 subsets of SMPRSs (or 4 SMPRS-IDGs) are combined together and injected into the assay plate well so as to provide approximately the same number of SMPs for each SMPRS.

Each SMPRS will present a distribution of readings. In the Luminex® system, a variety of information is presented to the user, including mean and trimmed mean, peak and trimmed peak, (which peak values are similar to mode) and median and trimmed median. It is often recommended to use median. In practice, it makes little difference which is used as long as the choice is consistent. Whichever value is chosen for use, that value becomes the reading from the instrument for the SMPRSs. For each of the 4 identical group subsets of 5 SMPRSs in turn, (for each SMPRS-IDG) any outlier readings in the subset of 5 SMPRSs may be removed if desired. Then the remaining readings of the subset are used to generate a mean average. This will result in 4 identical group subset averages (4 “means of the sets of n SMPRSs”, one for each SMPRS-IDG). Since the reference subsets have varying signal strengths the subset averages will differ.

A reference intraplex average (mean of the set of m SMPRS-IDGs) is then calculated by taking the mean of the 4 subset averages. 4 ratios may then be calculated using the subset averages (means of the sets of n SMPRSs) as numerators and the intraplex-average (mean of the set of m SMPRS-IDGs) as denominator. Following this, 4 p and 4 q ratios can be taken against any of the SMPCS assays.

Example 3—A degenerate second-order intraplex. In this alternative embodiment and example, m=1 and n=1, meaning only one SMPRS is used although n could be greater than one as long as m remains equal to one. In the Luminex® system, one might select SMPRS 006. The SMPRS is then put into a reaction vessel. Some fluorophore is attached to or embedded in the surface of the SMPRS. After the manufacturing steps are complete, the SMPRS is injected into the assay plate well so as to provide the same number of SMPs for each SMPRS. Readings for the SMPRS are then collected as in previous examples. Following collection of the reading, the reading would be used to generate one q ratio against each SMPCS assay.

While the invention has been described in connection with specific embodiments thereof, it will be understood that it is capable of further modifications and this application is intended to cover any variations, uses, or alterations of the invention following. In general, the principles of the invention and including such departures from the present disclosure as come within known or customary practice within the art to which the invention pertains and as may be applied to the essential features hereinbefore set forth and as follows in the scope of the appended claims.

I claim:

1. A method for improving the reliability and comparability of readings from a single sample, the method comprising:
a. placing a first reference signal emitter on a microparticle media for reading by an instrument, together with a second assay placed on microparticle media which second assay emits signal on the same channel as the first reference signal emitter, the first reference signal emitter comprising;
i. m number of SMPRS-IDGs, wherein each said SMPRS-IDG exhibits a substantially different signal intensity and comprises n number of SMPRSs, wherein each said SMPRS is designed to exhibit a substantially identical signal level on one or more reporter channels when read by said instrument and each;
ii. wherein m is an integer of at least 1 and n is an integer of at least 1; and
iii. wherein m and n are not required to be the same value and n is not necessarily the same value for each m;
b. placing said first reference signal emitter into said single sample together with said second assay, the second assay comprising;
i. m number of SMPCS-IDG assays targeted at a common analyte, wherein each said SMPCS-IDG assay is designed to exhibit a different response level to said common analyte, wherein each said SMPCS-IDG assay comprises n number of SMPCS assays, wherein each said SMPCS assay is designed to exhibit a substantially identical response level to said common analyte;
ii. wherein m is an integer of at least 1 and n is an integer of at least 1;
iii. wherein if m equals 1 then n is greater than 1 and if n equals 1 then m is greater than 1; and
iv. wherein m and n are not required to be the same value and n is not necessarily the same value for each m;
c. obtaining a first SMPRS reading from each said first SMPRS reference signal emitter in each said SMPRS-IDG, wherein there are n number of first SMPRS readings for each of said m number of SMPRS-IDG assays; and
d. obtaining a second SMPCS reading from each said SMPCS second assay in each said SMPCS-IDG, wherein there are n number of SMPCS readings for each of said m number of SMPCS-IDG assays.

2. The method according to claim 1 further comprising the step of removing outlier values from said n number of first SMPRS readings if the outlier values are present.

3. The method according to claim 2 further comprising the step of taking one of either an arithmetic mean average, geometric mean average, harmonic mean average, or quadratic mean average of said n number of first SMPRS readings to generate m means of the sets of n SMPRSs, one mean of the set of n SMPRSs for each SMPRS-IDG.

4. The method according to claim 3 further comprising the step of taking one of either an arithmetic mean average, geometric mean average, harmonic mean average, or quadratic mean average of said m means of the sets of n SMPRSs to calculate a mean of the set of m SMPRS-IDGs.

5. The method according to claim 4 further comprising the step of determining an m ratio set, comprising m ratios of each of said m means of the sets of n SMPRSs to said mean of the set of m SMPRS-IDGs.

6. The method according to claim 4 further comprising the step of taking q ratios to said second assay, said q ratio set comprising one or more of said m means versus one or more SMPCS readings of said second assay, where said one or more m means or one or more SMPCS readings could occupy either numerator or denominator position, provided that neither could be numerator and denominator simultaneously.

7. The method according to claim 5 further comprising the step of taking p ratios to said second assay, said p ratio set comprising one or more of said m ratios versus one or more SMPCS readings of said second assay, where said one or more m ratios or one or more SMPCS readings could occupy either numerator or denominator position, provided that neither could be numerator and denominator simultaneously.

8. The method of claim 4, 5, 6 or 7, further comprising the steps of:
a. creating a calibration dataset by running multiple samples of known concentrations of a common analyte at different concentrations and
b. recording for each of said multiple samples of known concentrations of said common analyte one or more of:
i. said known concentration of said common analyte;
ii. said SMPRS readings from each SMPRS first reference signal emitter;
iii. said m number for said SMPRS-IDGs in the first reference signal emitter;
iv. said n number for the SMPRSs in each SMPRS-IDG in the first reference signal emitter;
v. a list of classifiers for each SMPRS-IDG assay;
vi. said SMPCS readings from each said SMPCS second assay;
vii. said m number for said SMPCS-IDGs in the second assay;
viii. said n number for the SMPCSs in each SMPCS-IDG in the second assay; and
ix. a list of classifiers for each SMPCS-IDG making up the second assay.

9. The method of claim 8, further comprising an additional calibration dataset created by recording summary data, for each said known concentration of said common analyte, for each SMPCS-IDG in said second assay, one or more of said q ratio set or said p ratio set.

10. The method according to claim 9, wherein range for one or more of said q ratio set or said p ratio set obtained from a non-calibration run sample are compared to the range of one or more of q ratio set or p ratio set calculated from said calibration dataset to estimate a probable range of concentration of analyte in said sample.

11. The method according to claim 9, wherein range for one or more of said q ratio set or said p ratio set obtained from a non-calibration sample are compared to the range of one or more of q ratio set or p ratio set calculated from said calibration dataset to estimate a probable range of concentration of analyte in said sample using a k nearest neighbor algorithm.

12. The method according to claim 9, wherein range for one or more of said q ratio set or said p ratio set obtained from a non-calibration sample are compared to the range of one or more of q ratio set or p ratio set calculated from said calibration dataset to estimate a probable range of concentration of analyte in said sample by comparing fitted curves based on the q or p ratio sets mentioned in this claim.

13. The method according to claim 9, wherein range for one or more of said q ratio set or said p ratio set obtained from a non-calibration sample are compared to the range of one or more of q ratio set or p ratio set calculated from said calibration dataset to estimate a probable range of concentration of analyte in said sample by comparing derivatives of fitted curves based on the q or p ratio sets mentioned in this claim.

14. The method according to claim 1 wherein the first reference signal emitter may be microparticles configured mounted permanently on a surface, or scattered temporarily on a surface together with assay particles.

15. The method according to claim 1 wherein the first reference signal emitter may be microparticles configured present in a fluid and where the method of identifying microparticle sets is a different method than fluorescence.

16. A method for improving calibration of an instrument, the method comprising:
a. placing a first reference signal emitter in one or more channels placed on or incorporated into a microparticle media for reading by an instrument, the first reference signal emitter comprising;
i. m number of SMPRS-IDGs, wherein each said SMPRS-IDG exhibits a substantially different signal level and comprises n number of SMPRSs, wherein each said SMPRS is designed to exhibit a substantially identical signal level on one or more reporter channels when read by said instrument and each;
ii. wherein m is an integer greater than 1 and n is an integer of at least 1; and
iii. wherein m and n are not required to be the same value and n is not necessarily the same value for each m;

17. The method according to claim 16 further comprising the step of removing outlier values from said n number of first SMPRS readings if the outlier values are present.

18. The method according to claim 17 further comprising the step of taking one of either an arithmetic mean average, geometric mean average, harmonic mean average, or quadratic mean average of said n number of first SMPRS readings to generate m means of the sets of n SMPRSs, one mean of the set of n SMPRSs for each SMPRS-IDG.

19. The method according to claim 18 further comprising the step of taking one of either an arithmetic mean average, geometric mean average, harmonic mean average, or quadratic mean average of said m means of the sets of n SMPRSs to calculate a mean of the set of m SMPRS-IDGs.

20. The method according to claim 19 further comprising the step of determining an m ratio set, comprising m ratios of each of said m means of the sets of n SMPRSs to said mean of the set of m SMPRS-IDGs.

21. The method according to claim 16 wherein the first reference signal emitter may be microparticles configured mounted permanently on a surface, or scattered temporarily on a surface together with assay particles.

22. The method according to claim 16 wherein the first reference signal emitter may be microparticles configured present in a fluid and where the method of identifying microparticle sets is a different method than fluorescence.
